(19) United States
(12) Patent Application Publication
(10) Pub. No.: US 2011/0023070 A1
(43) Pub. Date: Jan. 27, 2011

(54) Service Discovery in Broadcast Networks

(75) Inventors: Jani Petteri Vare, Kaarina (FI); Kari Sakari Virtanen, Merimasku (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/445,431

(22) PCT Filed: Oct. 11, 2006
(86) PCT No.: PCT/IB2006/002876

§ 371 Date: Apr. 20, 2010

(51) Int. Cl. H04N 7/16; G06F 15/177

(52) U.S. Cl. 725/62; 709/220

(57) ABSTRACT

Broadcast configuration data such as service information, program specific information and electronic service guide data may be misconfigured in non-standard or misconfigured broadcast networks. A network and data analysis server may be used to monitor network broadcasts for configuration information, check whether the configuration information is valid and transmit updated information to a central service discovery database system. The service discovery database system may be used to repair misconfigured or incomplete configuration information before storing it to a database. Terminals with fast service discovery enabled or that have received misconfigured data through the broadcast network may request configuration data from the service discovery database system. Additionally, terminals and/or network analysis servers may receive broadcast signals through a first network connection while communicating with the database system over a second network connection.

### BACKGROUND

Mobile communications technology has undergone significant advances in order to provide mobile terminal users with many of the services that are typically available in the home. Such services include television, radio, music, electronic messaging and other computing and communication capabilities. To provide such services and capabilities, networking protocols are often utilized to optimize the use of the underlying communication network(s). For example, digital video broadcasting spurred the creation of the Digital Video Broadcast (DVB) standard and, in particular, the DVB-Handheld specification. Such broadcast specifications are directed toward establishing a universal communication and broadcast protocol for distributing digital video services and improving compatibility of mobile devices with different networks.

Even with the creation and establishment of networking protocols and standards, network providers may often be unable or unwilling to implement the specifications defined by the protocols and standards. As such, networks that purport to broadcast using a particular protocol may often be incompatible with a user's mobile terminal due to protocol conflicts. In one example, broadcast information such as service information or electronic service guide data may be distributed in a DVB-H network in a format or other protocol standard (e.g., message sequence, incorrect responses) that deviates from the DVB-H protocol. Broadcast signals carrying the information may also be misconfigured or differently configured. In such instances, a mobile terminal adhering to and/or implementing the DVB-H specification may be unable to properly receive and/or decode the information. This may lead to problems and errors in processing broadcast content corresponding to the service information and/or electronic service guide data. Hardcoded terminals may be able to interact effectively with the differently configured network, but would still encounter conflicts when entering a network that does follow the DVB-H specification or is configured in yet another different manner.

### SUMMARY

This summary is provided to introduce a selection of concepts in a simplified form that are further described below in the Detailed Description. The Summary is not intended to identify key features or essential features of the claimed subject matter, nor is it intended to be used to limit the scope of the claimed subject matter.

A system and method for facilitating the distribution and discovery of service information is provided herein. Broadcast and network configuration data such as service information (SI), program specific information (PSI) and/or electronic service guide (ESG) data may be distributed through a broadcast network to one or more receiving terminals through an analysis server and a database system. The analysis server may be used to analyze configuration data collected from the broadcast network. The analysis server may determine whether the configuration data is valid and/or appropriately configured. The configuration data may be formed into a configuration information database and transmitted to a central database system for distribution to one or more requesting terminals. The central database system may be configured to process request messages from analysis servers and terminals alike. The database system may further evaluate the configuration information received from the analysis servers to determine whether the data is complete. If incomplete, the database system may repair the configuration information. A repair process may include reformatting, identifying and compensating for missing information, recoding data, replacing data and the like.

In another aspect, terminals and analysis servers may each include two receivers and one or more transmitters. One of the two receivers and a transmitter may be used to communicate through a first network connection using a first network protocol. The other receiver and, optionally, transmitter, may be used to communicate through a second network connection using a second network protocol. In one example, the first network connection and first network protocol may be used to send and receive data over a cellular network to and from a central database system. The second network connection and second network protocol may be used to receive broadcast content through a DVB-H network.

In yet another aspect, a terminal may request configuration information from a central service discovery database system if a fast discovery option is enabled. The central database system may repair misconfigured configuration information and provide such repaired data to requesting terminals. In one or more configurations, a terminal may request repaired configuration information from the database system in response to determining that configuration data received over the broadcast network is misconfigured. The terminal may request and receive data from the database system through a first channel or network connection while receiving broadcast data and content through a second channel or network connection. The terminal may then use the configuration information to process corresponding broadcast content received through the broadcast network.

According to still another aspect, an analysis server may monitor broadcast transmissions to determine whether configuration information has been updated or has changed. In response to determining that configuration data has changed, the analysis server may store the configuration data, add the configuration to a database and transmit the database to a central database system. In one or more arrangements, the analysis server might only send the updated or changed configuration information to the central database system.

In yet another aspect, a service discovery database system may receive and differentiate between download and upload request messages. In one example, download request messages may be received from mobile terminals receiving broadcast content while upload request messages may be received from analysis servers that monitor and update configuration information. In response to a download request, the database system may identify various parameters in determining the appropriate configuration data to transmit to the requesting terminal. Such parameters may include a physical location and a time interval. In response to an upload request, the database system may determine whether the received configuration information is complete and/or correctly configured. If it is not correctly configured and/or complete, the database system may repair the data using both automated and manual processes.

### BRIEF DESCRIPTION OF THE DRAWINGS

The foregoing summary of the invention, as well as the following detailed description of illustrative embodiments, is better understood when read in conjunction with the accompanying drawings, which are included by way of example, and not by way of limitation with regard to the claimed invention.

FIG. 1 illustrates a network system for broadcasting content to terminals in which one or more aspects described herein may be implemented.

FIG. 2 illustrates an example of a mobile device in accordance with one or more aspects described herein.

FIG. 3 illustrates a block diagram of a network and data analysis server according to one or more aspects described herein.

FIG. 4 is a flowchart illustrating a method for obtaining configuration data corresponding to broadcast content according to one or more aspects described herein.

FIG. 5 is a flowchart illustrating a method for processing configuration information upload and download requests according to one or more aspects described herein.

FIG. 6 is a flowchart illustrating a method for monitoring and analyzing configuration data according to one or more aspects described herein.

### DETAILED DESCRIPTION

In the following description of various illustrative embodiments, reference is made to the accompanying drawings, which form a part hereof, and in which is shown, by way of illustration, various embodiments in which the invention may be practiced. It is to be understood that other embodiments may be utilized and structural and functional modifications may be made without departing from the scope of the present invention.

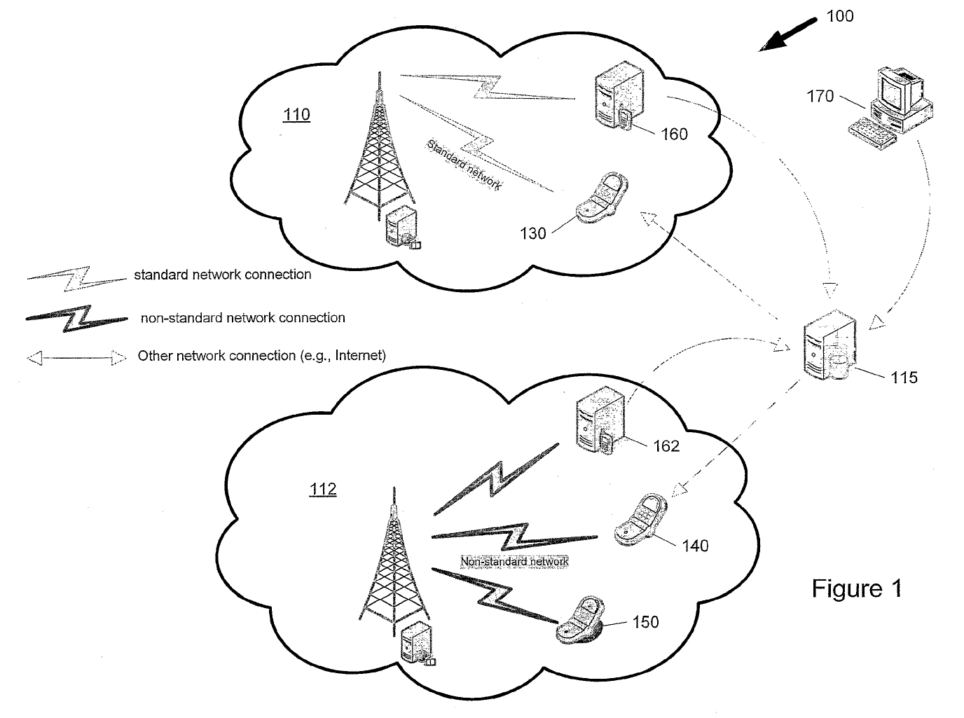

FIG. 1 illustrates a network system 100 including standard broadcast network 110, non-standard or misconfigured broadcast network 112 and database system 115. A standard network, as used herein, refers to a network that adheres to network standards and/or requirements defined by a network specification. Thus, in one example, a standard Digital Video Broadcast (DVB)-Handheld (H) network would be configured in accordance with the standards and/or requirements defined by the DVB-H specification. Other networking specifications may include DVB-Terrestrial (DVB-T) and DVB-H+ and other non-DVB protocols. In one or more arrangements, standard network 110 may be a standard DVB-H network. A non-standard or misconfigured network such as network 112, on the other hand, relates to a network that deviates from the standards and/or requirements set by the protocol or protocols used by the network. For example, signaling in a non-standard or misconfigured network might not conform to the standards specified by the network protocol (e.g., DVB-H). For example, a network may be misconfigured if a terrestrial delivery system descriptor is missing, if invalid cell coordinates are provided in a cell list descriptor, if a cell frequency link descriptor is missing, if invalid frequencies are used, if there is a cell identification mismatch and/or if tables are constructed in a manner that deviates from a network protocol or standard. Network standards and requirements may include predefined data format(s) and communication protocols (e.g., handshakes, packet sizes, etc.).

In standard network 110, terminal 130 may be used to receive broadcast content such as music, video, e-mail and the like from one or more content providers (not shown). Terminal 130 may be a mobile telephone, a personal data assistant (PDA), a video and/or audio player, a computer and/or other such devices. Broadcast content may be transmitted using Internet Protocol Datacasting (IPDC) and may be accompanied by configuration data that includes service information (SI), program specific information (PSI) and/or electronic service guide (ESG) data. Terminal 130 may use such configuration data to process the broadcast content for viewing or other consumption. For example, ESG data may be used by a user of terminal 130 to determine a schedule of shows or broadcasts and their corresponding channels. Configuration data may further provide terminal 130 with channel information so that terminal 130 may know the appropriate channel to which to tune for a particular program. Terminal 130 may be a standard receiver. That is, terminal 130 may be programmed in accordance with the standards defined by the network protocol (e.g., DVB-H protocol) used by network 110. Terminal 130 may, for instance, include software and/or hardware components for decoding incoming transmissions and/or formatting outgoing communications.

In one or more arrangements, while non-standard network 112 may be advertised or published as a DVB-H network, network 112 may deviate from one or more standards defined by the DVB-H specification. As such, communications facilitated through network 112 may encounter compatibility conflicts. For example, the formatting of content distributed through non-standard network 112 may differ from standard DVB-H specifications. As such, standard terminal 140 may be unable to decode the distributed content. Even if standard terminal 140 is able to decode the content, the decoding process may require additional time, slowing down the content and distribution process. In some cases, non-standard terminals such as terminal 150 may be used for compatibility with network 112. In one example, terminal 150 may be hardcoded with software and/or hardware components that are cognizant of the deviations in network 112. Thus, terminal 150 may be able to process content and communications without difficulty. Although terminal 150 may operate satisfactorily in network 112, terminal 150 may encounter difficulties in communicating with other standard or differently configured networks.

To facilitate transmissions from networks 110 and 112 to terminals 130 and 140, networks 110 and 112 may each include a data analysis server 160 and 162, respectively, to collect and analyze data received from networks 110 and 112 and create a database of the received information. In one or more instances, servers 160 and 162 may further repair the collected data, if necessary. For example, in non-standard network 112, configuration information such as SI, PSI and ESG information may be misconfigured. Configuration/signaling information in transport stream packets, multiprotocol encapsulation (MPE) and MPE-forward error correction (FEC) sections, transmission parameter signaling (TPS) bits may also be misconfigured. In such instances, server 162 may be employed to determine whether the configuration data is appropriately configured and if not, to repair the data. For example, configuration information may be repaired by obtaining and filling in missing information either manually or automatically (e.g. data in terrestrial delivery system descriptor can be retrieved by tuning). In another example, manual configuration may be used to repair configuration information missing ESG data (e.g., codecs/bitrates may be initially guessed, database created when correct codec/bitrate identified and working values determined). Accordingly, servers 160 and 162 may each establish and/or maintain connections to the content providers. Alternatively or additionally, servers 160 and 162 may create connections with an intermediate network node (not shown) that distributes content and other data for one or more content providers. Database system 115 may then be used to store the repaired or appropriately configured configuration data for subsequent transmission to requesting terminals (e.g., terminals 130 and 140). In one or more configurations, database system 115 may also be used to analyze and repair configuration information. For example, if manual configuration is required, the repair may be performed in database system 115.

Broadcast content and configuration data may be transmitted through networks 110 and 112 using a digital broadcast protocol such as DVB. Thus, to facilitate communications between terminals 130, 140 and 150 and the network, each of the terminals 130, 140 and 150 may include a digital broadcast receiver. Analysis servers 160 and 162 may also each include a digital broadcast receiver for receiving broadcast data from one or more entities on networks 110 and 112, respectively. In one or more arrangements, each of terminals 130, 140 and 150 as well as servers 160 and 162 may also include a transmitter for communicating with network entities such as database system 115. The transmitter may be configured according to one or more communication protocols such as cellular communications. Further, servers 160 and 162 and terminals 130, 140 and 150 may each include a second receiver for receiving data and other communications from database system 115 over a different network connection (i.e., not the digital broadcast network connection). The transmitter and second receiver of each device 130, 140, 150, 160 and 162 may operate over different types of network connections/channels using different networking protocols than the first receiver. For example, the transmitter and second receiver may communicate over cellular network connections, General Packet Radio Signal (GPRS) network connections, Uniform Mobile Telecommunication System (UMTS) network connections (e.g., EDGE network) and the like. Configuration and other data may also be delivered through flash ROM memory. A transceiver may also be used in place of or in addition to a transmitter and receiver pair. Further, the network connections between system entities 115, 130, 140, 150, 160 and 162 may be established using either wireless or wired techniques or both.

Alternatively or additionally, system 100 may further include terminal 170 that allows a network administrator or operator to manually repair or reconfigure the data received and stored in database 115. For example, a new error or configuration issue may arise for which servers 160 and 162 and/or database 115 might not yet be able to compensate. As such, manual reconfiguration or correction of the error may be performed. In another example, configuration data may be incomplete. Accordingly, manual modification of the configuration data may be necessary to provide complete information to request terminals 130, 140 and/or 150. Terminal 170 may be a remote device or may be local to database 115.

In one or more arrangements, system 100 may combine the functionalities of servers 160 and 162 with database 115. Thus, a combined system (e.g., a server) may collect, analyze and repair configuration information received over a broadcast network such as network 110 or 112 and provide the repaired data to requesting terminals such as terminals 130, 140 and 150.

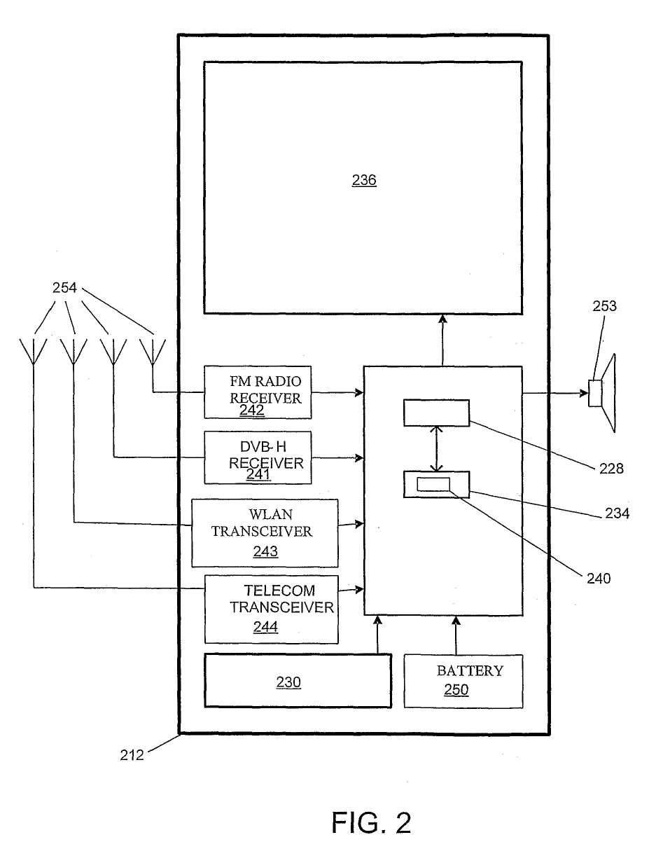

As shown in FIG. 2, a terminal such as mobile terminal 212 may include processor 228 connected to user interface 230, memory 234 and/or other storage, and display 236. Mobile terminal 212 may also include battery 250, speaker 252 and antennas 254. User interface 230 may further include a keypad, touch screen, voice interface, one or more arrow keys, joy-stick, data glove, mouse, roller ball, touch screen, or the like.

Computer executable instructions and data used by processor 228 and other components within mobile terminal 212 may be stored in a computer readable memory 234. The memory may be implemented with any combination of read only memory modules or random access memory modules, optionally including both volatile and nonvolatile memory. Software 240 may be stored within memory 234 and/or storage to provide instructions to processor 228 for enabling mobile terminal 212 to perform various functions. Alternatively, some or all of mobile device 212 computer executable instructions may be embodied in hardware or firmware (not shown).

Mobile terminal 212 may be configured to receive, decode and process digital broadband broadcast transmissions that are based, for example, on the Digital Video Broadcast (DVB) standard, such as DVB-H, DVB-H+, or DVB-MHP, through a specific DVB receiver 241. The mobile device may also be provided with other types of receivers for digital broadband broadcast transmissions. Additionally, mobile terminal 212 may also be configured to receive, decode and process transmissions through FM/AM Radio receiver 242, WLAN transceiver 243, and telecommunications transceiver 244. Transceivers 243 and 244 may, alternatively, be separated into individual transmitter and receiver components (not shown). In one aspect of the invention, mobile terminal 212 may receive Radio Data System (RDS) messages.

In an example of the DVB standard, one DVB 10 Mbit/s transmission may have 200, 50 kbit/s audio program channels or 50, 200 kbit/s video (TV) program channels. The mobile terminal 212 may be configured to receive, decode, and process transmission based on the DVB-H standard or other DVB standards, such as DVB-MHP, DVB-Satellite (DVB-S), or DVB-T. Similarly, other digital transmission formats may alternatively be used to deliver content and information of availability of supplemental services, such as ATSC (Advanced Television Systems Committee), NTSC (National Television System Committee), ISDB-T (Integrated Services Digital Broadcasting—Terrestrial), DAB (Digital Audio Broadcasting), DMB (Digital Multimedia Broadcasting), FLO (Forward Link Only) or DIRECTV. Additionally, the digital transmission may be time sliced, such as in DVB-H technology. Time-slicing may reduce the average power consumption of a mobile terminal and may enable smooth and seamless handover. Time-slicing entails sending data in bursts using a higher instantaneous bit rate as compared to the bit rate required if the data were transmitted using a traditional streaming mechanism. In this case, the mobile terminal 212 may have one or more buffer memories for storing the decoded time sliced transmission before presentation.

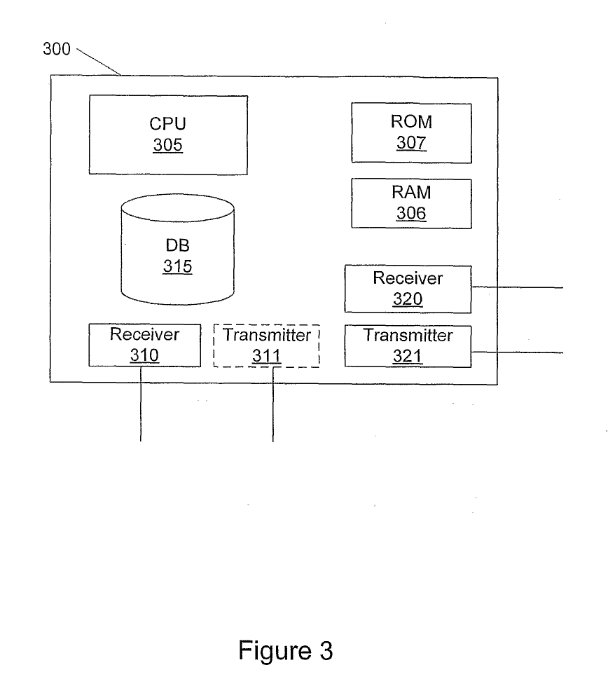

FIG. 3 illustrates a data analysis server 300 for verifying information transmitted through a broadcast network and repairing the information, if necessary. Analysis server 300, like terminal 212 of FIG. 2, may include multiple receivers 310 and 320 and one or more transmitters 321 and, in some instances, 311. Each receiver 310 and 320 and transmitter 311 and 321, may be used to communicate and otherwise interact over different networks or network connections and using different networking protocols. For example, receiver 310 may include a digital broadcast receiver configured to receive data over a DVB-H network connection or channel. Receiver 320 and transmitter 321, on the other hand, may be configured for communications over a cellular network connection using, for example, GPRS protocols. In one or more arrangements, digital broadcast receiver 310 may be used to receive configuration data or content from a content source or provider over a broadcast network such as network 160 of FIG. 1 while receiver 320 and transmitter 321 may be used to communicate with a central database such as database 115 of FIG. 1. In one or more configurations, server 300 may include digital broadcast transmitter 311 for broadcasting data from server 300 in a digital format.

Server 300 may further include processor 305, storage facility 315, random access memory (RAM) 306 and read-only memory (ROM) 307. RAM 306 may be used to temporarily store application data and/or instructions. Instructions and data stored in RAM 306 may be stored and accessed in any order, providing equal accessibility to the various storage locations in RAM 306. ROM 307 allows data stored thereon to persist or survive even after server 300 is powered down or has been turned off. Further, storage facility 315 may provide long term storage for a variety of data including application data, configuration information and content data. In one example, processor 305 may retrieve a network and/or data analysis program from storage 315, temporarily store the instructions associated with the application in RAM 306 while the application is executing, and store the analysis results of the program in a database of storage 315. The analysis results and other data stored in storage facility 315 may be subsequently transmitted to another device or entity in the network (e.g., a central database) using transmitter 321. One of skill in the art will appreciate that a variety of other components may be included in a server like server 300 based on desired functionality.

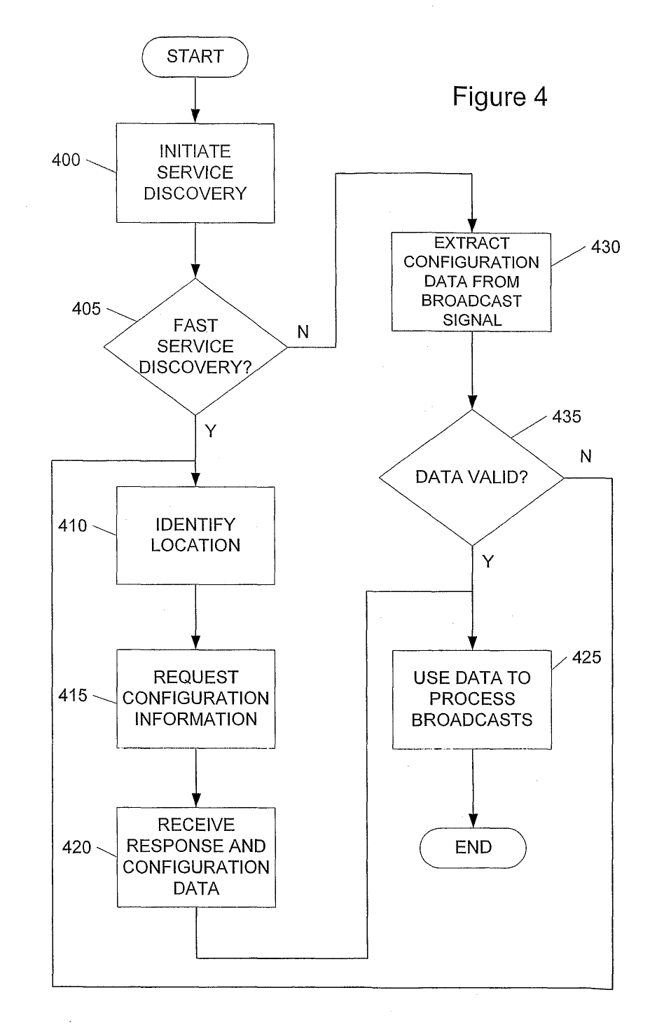

FIG. 4 is a flowchart illustrating a method for discovering services in a broadcast network. In step 400, a mobile terminal, e.g. terminal 130, 140 or 150, may initiate service discovery processes. For example, a terminal may look for services upon powering on and/or when entering a new service area. In step 405, the terminal may determine whether fast service discovery is desired. This determination may be made based on a predefined configuration, user-set options or a prompt to the user requesting a yes or no response. In some instances, users might not wish to use fast service discovery as such as process may require additional airtime and thus, additional costs. In response to a determination that fast service discovery is desired, the terminal may determine its location in step 410 so that the terminal requests the appropriate service information. In one or more arrangements, step 410 might not be performed. Instead, the network may independent determine the location (e.g., network cell in which terminal is currently located) of the terminal. Location information may be determined using various technologies and methods including Global Positioning Systems (GPS), triangulation and manual input by a user. In one or more configurations, a terminal may present the user with a list of locations (e.g., countries, states, counties, cities, zipcodes, etc.) from which the user may select a location. The list of locations may be retrieved from local storage in the terminal or may be obtained from a central database.

In step 415, once the terminal has determined its location, the terminal may transmit a request for configuration information to a service discovery database system. The request may include a variety of other information including identification of the terminal and/or user, parameters for the desired configuration data (e.g., time intervals, particular channel information, subject matter, etc.), terminal capabilities (e.g., audio only, video and audio) and/or combinations thereof. In step 420, the terminal may receive a response from the service discovery database system providing the requested configuration data. The configuration data may include service information, PSI and/or ESG data. The configuration information may then be used in step 425 to decode and/or otherwise be applied to corresponding broadcast content received over a broadcast network connection independent of the network connection through which the configuration data was requested and received. For example, the configuration data may be used to identify the channels and show times associated with particular programs.

If, however, a determination is made that fast discovery is not desired or specified in step 405, the terminal may initiate a signal scan to detect broadcast signals available in a broadcast network. If the terminal detects a broadcast signal, the terminal may extract or otherwise obtain configuration information from the broadcast signal in step 430. For example, configuration data may be embedded in and extracted from a vertical blanking interval (VBI) of a broadcast signal. In step 435, the terminal may further analyze the configuration information to determine whether the data is configured correctly. Whether the configuration information is valid or configured correctly may be determined based on a variety of considerations including if a terminal is able to set a broadcast platform and create filters. Alternatively or additionally, a terminal may perform a signal scan, set one or more platforms (e.g., all available platforms) and try each service to determine if the data is configured correctly. Further, in one or more instances, the terminal may determine whether the data and/or broadcast signal is configured correctly based on whether the data is complete. If the data is configured correctly, the terminal may then use the configuration information to decode and process the content portion of the broadcast signal, as illustrated in step 425. If, however, the data or signal is misconfigured, the terminal may, in response, proceed to step 410 to obtain configuration information from the database system through a second network connection. The configuration data obtained from the broadcast signal may, in one or more configurations, be discarded.

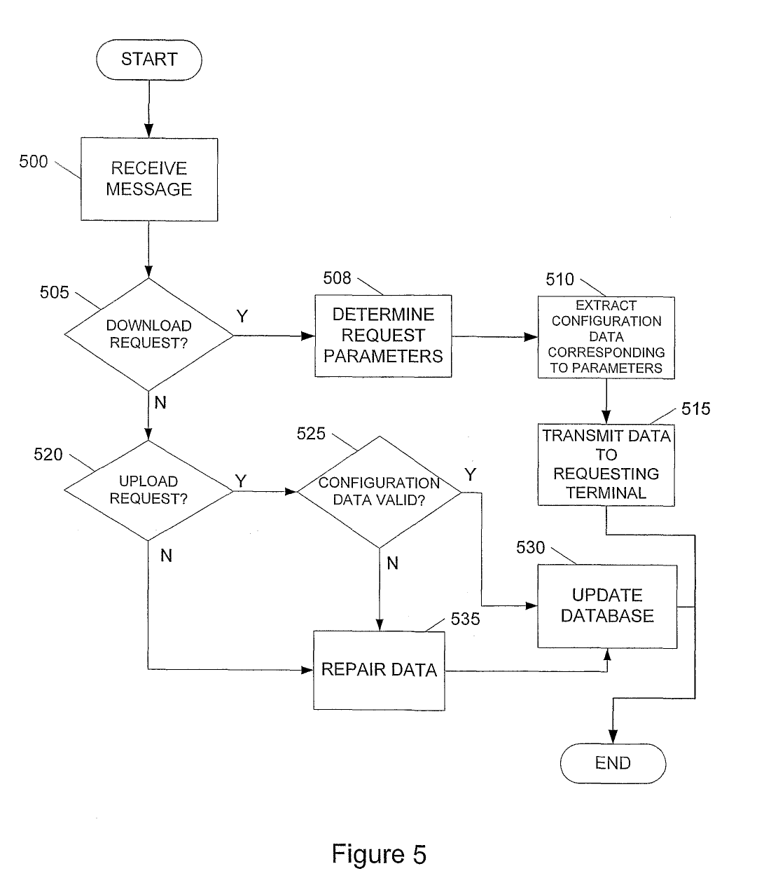

FIG. 5 is a flowchart illustrating a method for providing configuration data to requesting terminals. In step 500, a service discovery database system may receive a message associated with configuration data such as SI, PSI and ESG information. The message may be received from a variety of sources including a user's mobile terminal or an analysis server. The message may further correspond to either a data upload request or a download request. Accordingly, in step 505, the service discovery database system may determine whether the message corresponds to a download request. In response to determining that the message is a download request, the database system may determine one or more request parameters from the request message in step 508. For example, the database system may identify the requesting terminal or user's location, desired service information, time parameters and/or combinations thereof from the request message. Based on the specified parameters, the database system may extract the appropriate configuration information from storage and transmit the data to the requesting terminal in steps 510 and 515, respectively. In one or more configurations, the database system may transmit the configuration information to the requesting terminal over a network connection independent from the broadcast network connection through which the terminal may be receiving broadcast content corresponding to the configuration information. Alternatively or additionally, the database system may also set the configuration data transmitted to requesting terminals as read-only so that the data is not updated with misconfigured or erroneous data.

If, in step 505, it is determined that the message does not correspond to a download request, the database system may determine whether the message corresponds to an upload message in step 520. Upload requests may be received from a variety of network entities including an analysis server and/or a user terminal. Upon determining that the message is an upload request, the database system may evaluate the received configuration data to determine whether the uploaded configuration data is complete and/or otherwise valid in step 525. Validity of data may be evaluated based on a variety of factors including accuracy and recency (i.e., whether the data is up-to-date). Validity may further be based on whether the data is formatted or encoded in accordance with a particular network protocol. If the received configuration data is determined to be valid and/or complete, the database system may, in response, update its database(s) using the received configuration data in step 530.

If, however, the database system determines that the configuration information is incomplete or misconfigured in step 525, the database system may repair the data in step 535. Repairing configuration information may include reformatting the information, decoding and/or encoding data, filling in missing data and the like. In one example, if a terrestrial delivery system descriptor is missing from the configuration data, the database system may request this information from an analysis server. The analysis server may determine the descriptor information by tuning. In one example, the analysis server may try various modulation parameters to attempt to get a lock. The correct parameters such as the descriptor information may then be identified once a lock is acquired. That is, descriptor information may be included in the modulation parameters used to obtain the lock. The database system may further seek, if necessary, manual assistance from a system operator or administrator who may be able to add missing data to the incomplete configuration data. Once the configuration data is repaired and/or complete, the configuration information may then be used to update the database system in step 530. Alternatively or additionally, the database system may further notify one or more terminals if configuration data in the database has changed. The database system may be aware of such terminals by requiring terminals that request information to register with the system.

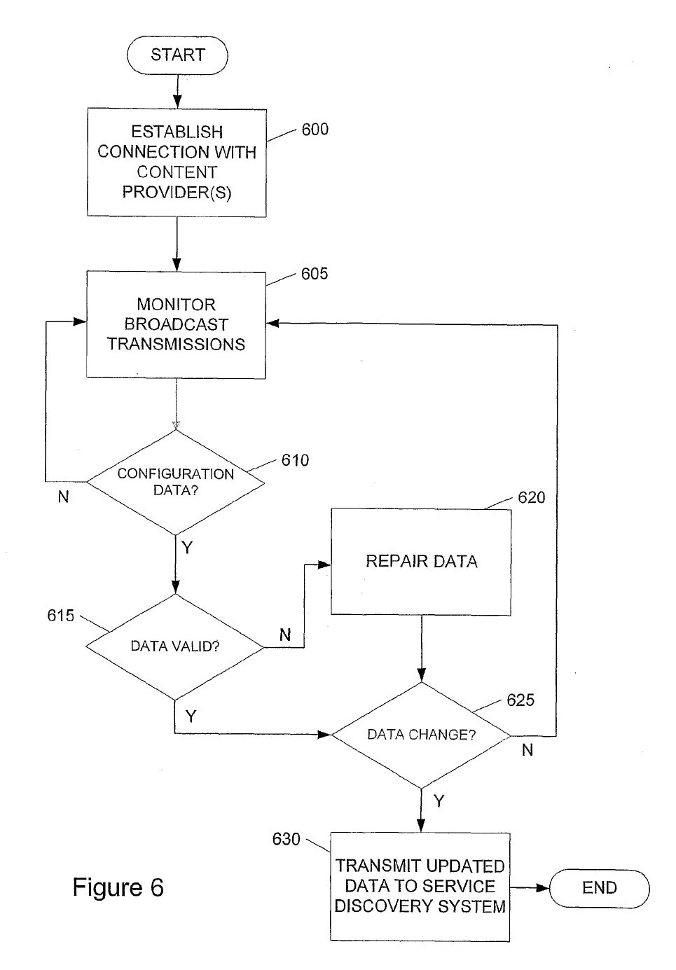

FIG. 6 is a flowchart illustrating a method for monitoring and updating network configuration data. Beginning in step 600, an analysis server may establish a first connection with one or more content providers. Once the connection has been established, the analysis server may monitor transmissions through the broadcast network in step 605. In step 610, the analysis server may determine whether the transmissions relate to configuration data. For example, analysis server may receive transmissions, decode the transmissions and evaluate the contents thereof to determine whether configuration information is included. If configuration information is not included, the analysis server may return to monitoring the network, as described in step 605. If, however, configuration data is included in the transmission, the analysis server may evaluate the configuration data to determine whether the data is valid in step 615. Again, validity of the data may be determined based on whether the data is configured in accordance with one or more protocol standards. Other factors may also be used to evaluate the validity of the received configuration information. If the data is invalid, the server may, in one or more instances, repair the data in step 620.

Once the data has been repaired or if the data is determined to be valid, the server may proceed to determine whether the configuration data includes changed information in step 625. In one example, the analysis server may compare the received configuration information with data stored in a local database to determine whether a change has occurred. If a change is detected in step 625, the server may generate and transmit an update message to a service discovery database system (e.g., database system 115 of FIG. 1) in step 630. The update message may include the entire locally stored database or, alternatively, might include only the updated portions. If, on the other hand, no change is detected in step 625, the analysis server may return to monitoring the network for configuration data in step 605.

While illustrative systems and methods as described herein embodying various aspects of the present invention are shown, it will be understood by those skilled in the art, that the invention is not limited to these embodiments. Modifications may be made by those skilled in the art, particularly in light of the foregoing teachings. For example, each of the elements of the aforementioned embodiments may be utilized alone or in combination or subcombination with elements of the other embodiments. It will also be appreciated and understood that modifications may be made without departing from the true spirit and scope of the present invention. The description is thus to be regarded as illustrative instead of restrictive on the present invention.

We claim:

1. A method for discovering configuration information at a terminal, comprising the steps of:
receiving, at a first receiver of the terminal, a broadcast signal through a first network connection, wherein the broadcast signal includes broadcast content and original configuration information; and
receiving, at a second receiver of the terminal, repaired configuration information through a second network connection, wherein the repaired configuration information corresponds to the broadcast signal received through the first network connection; and
processing the broadcast signal received at the first receiver in accordance with the repaired configuration information received at the second receiver.

2. The method of claim 1, wherein the first network connection includes a Digital Video Broadcast (DVB) network connection.

3. The method of claim 1, wherein the second network connection includes at least one of a General Packet Radio Service (GPRS) network connection, a Universal Mobile Telecommunication System (UMTS) network connection and a cellular communication network connection.

4. The method of claim 1, wherein the configuration information includes at least one of program specific information and service information.

5. The method of claim 1, wherein the repaired configuration information includes a repaired version of the original configuration information.

6. The method of claim 1, wherein the original configuration information is misconfigured.

7. A method for discovering configuration information at a terminal, comprising the steps of:
receiving a broadcast signal through a first network connection, wherein the broadcast signal includes first configuration data;
determining whether the first configuration data is valid; and
in response to determining that the first configuration data is not valid, requesting second configuration data from a service discovery database system through a second network connection.

8. The method of claim 7, wherein the second configuration data includes a repaired version of the first configuration data.

9. The method of claim 7, wherein the first configuration data is misconfigured.

10. The method of claim 7, further comprising the step of using the second configuration data to process broadcast content included in the broadcast signal.

11. A system for providing configuration data to mobile terminals, the system comprising:
a configuration information database; and
a data analysis server configured to:
receive configuration data through a first network connection from a broadcast network;
determine whether the configuration data is valid;
in response to determining that the configuration data is not valid, repairing the configuration data; and
storing the configuration data in the configuration information database.

12. The system of claim 11, wherein the data analysis server is further configured to transmit the repaired configuration data to a remote database through a second network connection.

13. The system of claim 11, wherein the data analysis server is configured to determine whether the configuration data is valid based on whether the configuration data is complete.

14. The system of claim 11, wherein the data analysis server is further configured to monitor the broadcast network for changes to the configuration data.

15. The system of claim 14, wherein the data analysis server is further configured to transmit updated configuration data to the database system in response to detecting changes to the configuration data.

16. A server for distributing configuration data, the server comprising:
a processor;
a receiver;
a transmitter; and
memory storing computer readable instructions that, when executed, cause the processor to perform a method comprising the steps of:
receiving a request message through the receiver;
determining whether the request message corresponds to an upload request; and
in response to determining that the request message corresponds to the upload request:
receiving configuration data;
determining whether the configuration data is valid; and
in response to determining that the configuration is not valid, repairing the configuration data.

17. The server of claim 16, wherein the memory further stores instructions for performing the steps of:
determining whether the request message corresponds to a download request; and
in response to determining that the request message corresponds to the download request, transmitting configuration data to a requesting terminal.

18. The server of claim 17, wherein the download request includes location information corresponding to the requesting terminal.

19. The server of claim 16, wherein repairing the configuration data includes obtaining user input to complete the configuration data.

20. The server of claim 16, wherein the memory further stores instructions for performing the steps of:
determining whether the configuration data includes new information; and
in response to determining that the configuration data includes new information, notifying one or more mobile terminals registered with the server.
